(19) United States
(12) Patent Application Publication
(10) Pub. No.: US 2006/0051585 A1
(43) Pub. Date: Mar. 9, 2006

(54) Laminate for display surface and process for producing the same

(75) Inventors: Koichi Mikami, Tokyo-To (JP); Midori Nakajo, Tokyo-To (JP); Norinaga Nakamura, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/206,673

(22) Filed: Aug. 18, 2005

(30) Foreign Application Priority Data
Sep. 6, 2004 (JP) 2004-258209

(51) Int. Cl. B32B 9/04; B05D 5/06

(52) U.S. Cl. 428/411.1; 427/162

(57) ABSTRACT

A laminate for use on a display surface, wherein the laminate comprises a low-refractive index layer on its surface and has a film surface-side 5-degree luminous reflectance on the low-refractive index layer side of not more than 3% and an in-plane average chromaticity (b*) in the range of +1.00 to −5.00.

### TECHNICAL FIELD

The present invention relates to a laminate adaptable for use on various display surfaces, an image display device using said laminate, and a process for producing said laminate.

### BACKGROUND OF THE INVENTION

Various laminates are used in various displays such as CRTs, liquid crystal panels, plasma displays, and electro luminescent displays for surface property improvement purposes. Such laminates include, for example, laminates having on the surface thereof a low-refractive index layer for reducing a deterioration in display quality caused by external light reflection, laminates comprising an antistatic layer for preventing adherence of dust or the like caused by electrification, and laminates comprising a hardcoat layer for preventing abrasion or scratch.

In such laminates, color shading sometimes occurs due to uneven thickness in the layers. For example, when a layer is formed on a concave-convex surface by a wet process such as printing, a color shading phenomenon is likely to occur in which, in the convex part and the concave part in the concave-convex surface, bluing and yellowing occur due to uneven thickness. In using this laminate in the front plate of a display, the visibility is significantly lowered and, in addition, disadvantageously, the quality level of the display is also deteriorated.

Accordingly, laminates in which such color shading was reduced have hitherto been desired. Such color shading can be eliminated by forming individual layers in even thickness. At the present time, however, the even thickness cannot be realized without use of a high-cost formation method, and this even thickness cannot be realized by a low-cost wet formation method such as printing without difficulties. Accordingly, the development of a laminate in which the color shading is in an acceptable level range, a laminate having a layer thickness which can realize color shading in the acceptable level range, and a method for layer formation which can realize color shading in the acceptable level range despite a low-cost method has been desired. For example, Japanese Patent Laid-Open No. 79600/2002 and Japanese Patent Laid-Open No. 292831/2003 may be mentioned as prior art techniques in this field.

### DISCLOSURE OF THE INVENTION

An object of the present invention is to provide a laminate for use on a display surface which can solve the above problems of the prior art, that is, a laminate in which the color shading is in an acceptable level range, a laminate having a layer thickness which can realize color shading in the acceptable level range, and a method for layer formation which can realize color shading in the acceptable level range despite a low-cost method.

The present inventor has found an advantageous laminate for use on a display surface, that is, a laminate in which the color shading is in an acceptable level range, a laminate having a layer thickness which can realize color shading in the acceptable level range, and a method for layer formation which can realize color shading in the acceptable level range despite a low-cost method. This has led to the completion of the present invention.

Thus, according to the present invention, there is provided a laminate for use on a display surface, wherein said laminate comprises a low-refractive index layer on its surface and has a film surface-side 5-degree luminous reflectance on the low-refractive index layer side of not more than 3% and an in-plane average chromaticity (b*) in the range of +1.00 to −5.00.

Preferably, the laminate according to the present invention comprises at least a base material layer and a hardcoat layer and further comprises the low-refractive index layer on the surface of the hardcoat layer.

Preferably, in the laminate according to the present invention, the average chromaticity (b*) is in the range of 0.00 to −3.00.

Preferably, in the laminate according to the present invention, the difference between the maximum b* value and the minimum b* value within 1 m square in an identical plane is not more than 2.50 when b* falls within a range astride 0 (zero) and is not more than 4.00 when b* falls within a range not astride 0 (zero).

Preferably, in the laminate according to the present invention, the laminate surface is a concave-convex form and has anti-dazzling properties.

Preferably, in the laminate according to the present invention, the low-refractive index layer has been formed by a wet process.

According to the present invention, there is provided a laminate for use on a display surface, wherein said laminate comprises a low-refractive index layer on its surface and said low-refractive index layer satisfies requirements represented by formulae
50≦d≦150 and
100−0.75/(1.46-n)≦d≦100+0.75/(1.46-n)
wherein d represents the thickness of the low-refractive index layer in nanometer; and n is the refractive index of the low-refractive index layer and is 1.3≦n≦1.45.

Preferably, the laminate according to the present invention has a film surface-side 5-degree luminous reflectance on the low-refractive index layer side of not more than 3% and an in-plane average chromaticity (b*) in the range of +1.00 to −5.00.

Further, according to the present invention, there is provided an image display device comprising the above laminate provided on the surface of a display.

According to the present invention, there is provided a process for producing the above laminate, said process comprising forming said low-refractive index layer in said laminate by a microgravure method.

Further, according to the present invention, there is provided a process for producing the above laminate, said process comprising forming said low-refractive index layer in said laminate by using a composition with a leveling agent added thereto.

Furthermore, according to the present invention, there is provided a process for producing the above laminate, said process comprising the step of, after coating of a composition for low-refractive index layer formation, turning the surface on which the composition for low-refractive index layer formation has been coated upside down within a drying hood.

Furthermore, according to the present invention, there is provided a process for producing the above laminate, said process comprising forming said low-refractive index layer in said laminate by using a composition for low-refractive index layer formation of which the viscosity is highly dependent upon solid content.

The present invention can provide laminates for use on a display surface, that is, a laminate in which the color shading is in an acceptable level range, and a laminate having a layer thickness which can realize color shading in the acceptable level range, and a method for layer formation which can realize color shading in the acceptable level range despite a low-cost method.

### BEST MODE FOR CARRYING OUT THE INVENTION

Laminate

The laminate according to the present invention is not particularly limited so far as it is used on the surface of a display. Preferably, the laminate has a concave-convex surface, for example, is an anti-dazzling laminate. The anti-dazzling laminate may be, for example, one which has surface concaves and convexes having an average convex spacing (Sm) of 20 to 200 μm and a center line average roughness (Ra) of 0.05 to 0.2 μm.

The layer construction of the laminate according to the present invention is not particularly limited so far as it has a low-refractive index layer on its surface. For example, the laminate may have a layer construction of a base material layer, a hardcoat layer, and a low-refractive index layer stacked in that order. These layers constituting the laminate may be layers commonly used in a laminate for a display surface. For example, TAC and PET may be used as the material for the base material layer. The hardcoat layer is preferably formed using a reactive curing resin, that is, a heat curing resin and/or an ionizing radiation curing resin or the like. Heat curing resins usable herein include phenolic resins, urea resins, diallyl phthalate resins, melamine resins, guanamine resins, unsaturated polyester resins, polyurethane resins, epoxy resins, aminoalkyd resins, melamine-urea co-condensation resins, silicone resins, and polysiloxane resins. In use, if necessary, for example, crosslinking agents, polymerization initiators, polymerization accelerators, solvents, and viscosity modifiers may be added to these resins.

Low-Refractive Index Layer

After lamination, the low-refractive index layer constituting the laminate according to the present invention has such properties that the film surface-side 5-degree luminous reflectance on the low-refractive index layer side is not more than 3% and the in-plane average chromaticity (b*) is in the range of +1.00 to −5.00. The average chromaticity (b*) is preferably in the range of 0.00 to −3.00. Preferably, the difference between the maximum b* value and the minimum b* value within 1 m square in an identical plane is not more than 2.50 when b* falls within a range astride 0 (zero) and is not more than 4.00 when b* falls within a range not astride 0 (zero). According to this construction, the visual color shading can fall within an acceptable level range.

In another embodiment of the present invention, the low-refractive index layer constituting the laminate satisfies requirements represented by formulae 50≦d≦150 and 100−0.75/(1.46-n)≦d≦100+0.75/(1.46-n) wherein d represents the thickness of the low-refractive index layer in nanometer; and n is the refractive index of the low-refractive index layer and is 1.3≦n≦1.45. According to this construction, the visual color shading can fall within an acceptable level range.

Production Process

The laminate according to the present invention can be produced in the same manner as used in the production of a conventional laminate for a display except for the formation of the low-refractive index layer.

The anti-dazzling layer according to the present invention may be formed using a transparent resin, and examples of such resins include thermoplastic resins, heat curing resins, and ionizing radiation curing resins. The thickness of the anti-dazzling layer is not less than 0.5 μm, preferably not less than 3 μm, from the viewpoint of imparting scratch resistance.

In order to further improve the scratch resistance of the anti-dazzling layer, the anti-dazzling layer is preferably formed using as a transparent resin a reactive curing resin, that is, a heat curing resin and/or an ionizing radiation curing resin or the like. Heat curing resins include phenolic resins, urea resins, diallyl phthalate resins, melamine resins, guanamine resins, unsaturated polyester resins, polyurethane resins, epoxy resins, aminoalkyd resins, melamine-urea co-condensation resins, silicone resins, and polysiloxane resins. In use, if necessary, for example, crosslinking agents, polymerization initiators, polymerization accelerators, solvents, and viscosity modifiers may be added to these resins.

Polymers, prepolymers, or monomers which, upon exposure to an ionizing radiation, are solidified as a result of a crosslinking polymerization reaction or the like, may be used as the ionizing radiation curing resin. Specific examples thereof include radical polymerizable compounds comprising a (meth)acryloyl group-containing compound such as (meth)acrylamide, (meth)acrylonitrile, (meth)acrylic acid, or (meth)acrylic acid (here (meth)acryloyl means acryloyl or methacryloyl), cation polymerizable comounds comprising a combination of epoxy, cyclic ether, cyclic acetal, lactone, vinyl monomer or cyclic siloxane with aryldiazonium salt, diaryliodonium salt or the like, and polyene-thiol compounds comprising a thiol group-containing compound, for example, trimethylolpropane trithioglycolate, trimethylolpropane tripropylate, pentaerythritol tetrathioglycol and a polyene compound.

Radical generators or deoxidizers may be added as reaction accelerators for the ionizing radiation curing resins. In the case of ultraviolet curing, one or at least two photoreaction initiators selected from, for example, benzoin, benzoin methyl ether, acetophenone, benzophenone, Michler's ketone, diphenyl sulfide, dibenzyl sulfide, diethyl oxide, triphenylbiimidazole, and isopropyl-N,N-dimethylaminobenzoate may be mixed in an amount of 0.1 to 10 parts by weight based on 100 parts by weight of the ionizing radiation curing resin.

If necessary, thermoplastic resins may be added to the ionizing radiation curing resin, and examples thereof include polyethylene, polystyrene, polymethyl methacrylate, and polybutyl methacrylate. Further, calcium carbonate, silica, alumina or other fillers or viscosity reducing agents, leveling agents, colorants, and luster pigments may be added. Further, waxes, silicones, fluorocompounds, and silicon acrylate, fluorinated acrylate or other reactive compounds and the like may be added.

In the production process of an anti-dazzling film according to the present invention, a concave-convex surface of the anti-dazzling layer may be formed by coating a coating material comprising a binder with a matte agent such as organic and/or fine particles added thereto onto a base material to form a coating.

In the present invention, the ionizing radiation refers to electromagnetic waves or charge particle radiations that have energy quantum capable of polymerizing or crosslinking molecules, and examples thereof include visible light, ultraviolet light, X-rays or other electromagnetic waves, or particle radiations such as electron beams. In general, ultraviolet light or electron beams are used.

Regarding ionizing radiation irradiation equipment used for curing the ionizing radiation curing resin according to the present invention, in the case of ultraviolet irradiation, light sources such as ultrahigh pressure mercury lamps, high pressure mercury lamps, low pressure mercury lamps, carbon arc, blacklight lamps, and metal halide lamps may be used. In the case of electron beam irradiation, various electron beam accelerators, such as Cockcroft-Walton accelerator, van de Graaff accelerator, resonance transformer, insulated core transformer, linear, dynamitron, and high-frequency electron accelerators are used. In the case of electron beam irradiation, electrons having an energy of generally 100 to 1000 KeV, preferably 100 to 300 keV are applied at a dose of about 0.1 to 30 Mrad.

The ionizing radiation curing resin may be coated onto a transparent base material by a method such as gravure, gravure reverse, roll, or Komma coating. The viscosity of the ionizing radiation curing resin at the time of coating is preferably not more than 1000 cps. The coating may be carried out by a solvent-free method without any volatile solvent, or by a method using a volatile solvent. In the case of the solvent-free method, a method may also be adopted in which an ionizing radiation curing resin, which has high viscosity at room temperature, is heated at about 40° C. to 70° C. to lower the viscosity to not more than 1000 cps.

In the laminate according to the present invention, the low-refractive index layer is preferably formed by a wet process such as printing. The method is not particularly limited so far as a desired low-refractive index layer is provided. Examples thereof include a microgravure method, a method in which a composition with a leveling agent added thereto is used, a method in which, after coating of a composition for low-refractive index layer formation, the coating surface of the composition for low-refractive index layer formation is turned upside down within a drying hood, and a method in which the low-refractive index layer is formed using a composition for low-refractive index layer formation which causes a significant increase in viscosity upon drying (the viscosity is highly dependent upon solid content).

Image Display Device

The laminate according to the present invention can be used on the surface of CRTs, liquid crystal panels, plasma displays, electro luminescent displays and the like and can be used as image display devices such as televisions, personal computers, PDAs, portable (cellular) phones, digital cameras, digital videos or other devices.

### EXAMPLES

### Example 1

A substrate concave-convex (anti-dazzling) film was prepared by a production process described above (HC refractive index about 1.50, average thickness 6000 nm, average concave-convex part thickness difference 200 nm, average spacing between convex parts 100 μm).

Thereafter, a low-refractive index layer was formed as follows.

A composition for low-refractive index layer formation was prepared by mixing according to the following formulation.

| | |
|---|---|
| Surface treated hollow silica sol | 12.85 pts.wt. |
| (20% methyl isobutyl ketone solution) | |
| Pentaerythritol triacrylate (PETA) | 1.43 pts.wt. |
| Irgacure 907 | 0.1 pt.wt. |
| (manufactured by Ciba Specialty Chemicals) | |
| F3035 (tradename; manufactured by | 0.4 pt.wt. |
| Nippon Oils & Fats Co., Ltd.) | |
| Methyl isobutyl ketone | 85.22 pts.wt. |

The composition for low-refractive index layer formation was bar coated, and the coating was dried to remove the solvent. Thereafter, ultraviolet light was applied at an exposure dose of 200 mJ/cm² with ultraviolet irradiation equipment (Fusion UV Systems Japan K.K., light source H bulb) to cure the coating. Thus, a laminate of base material/hardcoat/low-refractive index layer was prepared.

The chromaticity “b*” was measured with a spectrophotometric calorimeter (manufactured by Minolta Camera Co., Ltd., CM-3700d) in a transmission mode under illumination conditions of D65 and a view angle of 2 degrees in such a manner that the low-refractive index layer surface was used as a light incident face.

The results are shown in Table 1.

### Example 2

A substrate anti-dazzling film was prepared in the same manner as in Example 1. Thereafter, a low-refractive index layer was formed as follows.

A composition for low-refractive index layer formation was prepared by mixing according to the following formulation.

| | |
|---|---|
| Surface treated hollow silica sol | 10.65 pts.wt. |
| (20% methyl isobutyl ketone solution) | |
| Pentaerythritol triacrylate (PETA) | 3.55 pts.wt. |
| Irgacure 907 | 0.1 pt.wt. |
| (manufactured by Ciba Specialty Chemicals) | |
| F3035 (tradename; manufactured by | 0.4 pt.wt. |
| Nippon Oils & Fats Co., Ltd.) | |
| Methyl isobutyl ketone | 85.22 pts.wt. |

The composition for low-refractive index layer formation was bar coated, and the coating was dried to remove the solvent. Thereafter, ultraviolet light was applied at an exposure dose of 200 mJ/cm² with ultraviolet irradiation equipment (Fusion UV Systems Japan K.K., light source H bulb) to cure the coating. Thus, a laminate of base material/hardcoat/low-refractive index layer was prepared.

Measurement was carried out in the same manner as in Example 1. The results are shown in Table 1.

### Example 3

A substrate anti-dazzling film was prepared in the same manner as in Example 1. Thereafter, a low-refractive index layer was formed as follows.

A composition for low-refractive index layer formation was prepared by mixing according to the following formulation.

| | |
|---|---|
| Surface treated hollow silica sol | 10.65 pts.wt. |
| (20% methyl isobutyl ketone solution) | |
| Pentaerythritol triacrylate (PETA) | 3.55 pts.wt. |
| Irgacure 907 | 0.1 pt.wt. |
| (manufactured by Ciba Specialty Chemicals) | |
| F3035 (tradename; manufactured by | 0.4 pt.wt. |
| Nippon Oils & Fats Co., Ltd.) | |
| Isobutyl alcohol | 85.22 pts.wt. |

The composition for low-refractive index layer formation was bar coated, and the coating was dried to remove the solvent. Thereafter, ultraviolet light was applied at an exposure dose of 200 mJ/cm² with ultraviolet irradiation equipment (Fusion UV Systems Japan K.K., light source H bulb) to cure the coating. Thus, a laminate of base material/hardcoat/low-refractive index layer was prepared.

Measurement was carried out in the same manner as in Example 1. The results are shown in Table 1.

### Comparative Example 1

A substrate anti-dazzling film was prepared in the same manner as in Example 1. Thereafter, a low-refractive index layer was formed as follows.

A composition for low-refractive index layer formation was prepared by mixing according to the following formulation.

| | |
|---|---|
| Surface treated hollow silica sol | 12.85 pts.wt. |
| (20% methyl isobutyl ketone solution) | |
| Pentaerythritol triacrylate (PETA) | 1.43 pts.wt. |
| Irgacure 907 | 0.1 pt.wt. |
| (manufactured by Ciba Specialty Chemicals) | |
| F3035 (tradename; manufactured by | 0.4 pt.wt. |
| Nippon Oils & Fats Co., Ltd.) | |
| Isobutyl alcohol | 85.22 pts.wt. |

The composition for low-refractive index layer formation was bar coated, and the coating was dried to remove the solvent. Thereafter, ultraviolet light was applied at an exposure dose of 200 mJ/cm² with ultraviolet irradiation equipment (Fusion UV Systems Japan K.K., light source H bulb) to cure the coating. Thus, a laminate of base material/hardcoat/low-refractive index layer was prepared.

Measurement was carried out in the same manner as in Example 1. The results are shown in Table 1.

### Comparative Example 2

A composition for low-refractive index layer formation was prepared by mixing according to the following formulation.

| | |
|---|---|
| Surface treated hollow silica sol | 12.85 pts.wt. |
| (20% methyl isobutyl ketone solution) | |
| Pentaerythritol triacrylate (PETA) | 1.43 pts.wt. |
| Irgacure 907 | 0.1 pt.wt. |
| (manufactured by Ciba Specialty Chemicals) | |
| F3035 (tradename; manufactured by | 0.4 pt.wt. |
| Nippon Oils & Fats Co., Ltd.) | |
| Cyclohexanone | 85.22 pts.wt. |

The composition for low-refractive index layer formation was bar coated, and the coating was dried to remove the solvent. Thereafter, ultraviolet light was applied at an exposure dose of 200 mJ/cm² with ultraviolet irradiation equipment (Fusion UV Systems Japan K.K., light source H bulb) to cure the coating. Thus, a laminate of base material/hardcoat/low-refractive index layer was prepared.

Measurement was carried out in the same manner as in Example 1. The results are shown in Table 1.

### Comparative Example 3

A composition for low-refractive index layer formation was prepared by mixing according to the following formulation.

| | |
|---|---|
| Surface treated hollow silica sol | 10.65 pts.wt. |
| (20% methyl isobutyl ketone solution) | |
| Pentaerythritol triacrylate (PETA) | 3.55 pts.wt. |
| Irgacure 907 | 0.1 pt.wt. |
| (manufactured by Ciba Specialty Chemicals) | |
| F3035 (tradename; manufactured by | 0.4 pt.wt. |
| Nippon Oils & Fats Co., Ltd.) | |
| Cyclohexanone | 85.22 pts.wt. |

The composition for low-refractive index layer formation was bar coated, and the coating was dried to remove the solvent. Thereafter, ultraviolet light was applied at an exposure dose of 200 mJ/cm² with ultraviolet irradiation equipment (Fusion UV Systems Japan K.K., light source H bulb) to cure the coating. Thus, a laminate of base material/hardcoat/low-refractive index layer was prepared.

Measurement was carried out in the same manner as in Example 1. The results are shown in Table 1.

TABLE 1

| | Low-refractive index layer | | | 5-degree Reflection properties | | | | | Visual |
|---|---|---|---|---|---|---|---|---|---|
| | Refractive | Thickness of | Thickness of | Reflectance | b* in | Reflectance | b* in | b* | judgement of |
| | index | convex film | concave film | of convex | convex | of concave | concave | difference | color tone |
| Ex. 1 | 1.36 | 101 | 101 | 1.43% | −1.985 | 1.01% | −4.416 | 2.431 | ◯ |
| Ex. 2 | 1.40 | 98 | 98 | 2.17% | −0.857 | 1.64% | −2.690 | 1.833 | ◯ |
| Ex. 3 | 1.40 | 93 | 103 | 2.19% | −0.167 | 1.65% | −4.204 | 4.037 | ◯ |
| Comp. Ex. 1 | 1.36 | 96 | 106 | 1.45% | −0.640 | 1.02% | −6.649 | 6.009 | ◯Δ |
| Comp. Ex. 2 | 1.36 | 91 | 111 | 1.49% | 0.639 | 1.07% | −8.531 | 9.170 | X |
| Comp. Ex. 3 | 1.40 | 88 | 108 | 2.22% | 0.469 | 1.69% | −5.553 | 6.022 | ◯Δ |

1. A laminate for use on a display surface, wherein said laminate comprises a low-refractive index layer on its surface and has a film surface-side 5-degree luminous reflectance on the low-refractive index layer side of not more than 3% and an in-plane average chromaticity (b*) in the range of +1.00 to −5.00.

2. The laminate according to claim 1, which comprises at least a base material layer and a hardcoat layer and further comprises the low-refractive index layer on its surface.

3. The laminate according to claim 1, wherein said average chromaticity (b*) is in the range of 0.00 to −3.00.

4. The laminate according to claim 1, wherein the difference between the maximum b* value and the minimum b* value within 1 m square in an identical plane is not more than 2.50 when b* falls within a range astride 0 (zero) and is not more than 4.00 when b* falls within a range not astride 0 (zero).

5. The laminate according to claim 1, wherein said laminate surface is a concave-convex form and has anti-dazzling properties.

6. The laminate according to claim 1, wherein said low-refractive index layer has been formed by a wet process.

7. A laminate for use on a display surface, wherein said laminate comprises a low-refractive index layer on its surface and said low-refractive index layer satisfies requirements represented by formulae
50≦d≦150 and
100−0.75/(1.46-n)≦d≦100−0.75/(1.46-n)
wherein d represents the thickness of the low-refractive index layer in nanometer; and n is the refractive index of the low-refractive index layer and is 1.3≦n≦1.45.

8. The laminate according to claim 7, which has a film surface-side 5-degree luminous reflectance on the low-refractive index layer side of not more than 3% and an in-plane average chromaticity (b*) in the range of +1.00 to −5.00.

9. An image display device comprising a laminate according to claim 1 on the surface of a display.

10. A process for producing a laminate according to claim 1, said process comprising forming said low-refractive index layer in said laminate by a microgravure method.

11. A process for producing a laminate according to claim 1, said process comprising forming said low-refractive index layer in said laminate by using a composition with a leveling agent added thereto.

12. A process for producing a laminate according to claim 1, said process comprising the step of, after coating of a composition for low-refractive index layer formation, turning the surface on which the composition for low-refractive index layer formation has been coated upside down within a drying hood.

13. A process for producing a laminate according to claim 1, said process comprising forming said low-refractive index layer in said laminate by using a composition for low-refractive index layer formation of which the viscosity is highly dependent upon solid content.
